(19) United States
(12) Patent Application Publication
(10) Pub. No.: US 2026/0311296 A1
(43) Pub. Date: Oct. 8, 2026

(54) DEBANDING USING FILM GRAIN SYNTHESIS

(71) Applicant: NETFLIX, INC., Los Gatos, CA (US)

(72) Inventor: Andrey NORKIN, Campbell, CA (US)

(21) Appl. No.: 19/418,821

(22) Filed: Dec. 12, 2025

Related U.S. Application Data
(60) Provisional application No. 63/783,893, filed on Apr. 4, 2025.
(60) Provisional application No. 63/782,472, filed on Apr. 2, 2025.

(51) Int. Cl. G06T 5/20; G06T 5/70

(52) U.S. Cl. CPC G06T 5/20; G06T 5/70; G06T 2207/20182

(57) ABSTRACT

One embodiment sets forth a technique for reducing visibility of banding artifacts in a video stream. According to some embodiments, the technique includes the steps of receiving a video stream; generating, for at least one video frame of the video stream, an offset value corresponding to a banding artifact present in the video stream; generating modified noise based on the offset value; and adding the modified noise to the video stream to generate an output video stream. In other embodiments, filtering can be performed to determine an offset value based on filtered and unfiltered portions of the video stream. Thereafter, modified noise can be generated for the output video stream based on the offset value.

### CROSS-REFERENCE TO RELATED APPLICATIONS

The present application claims the benefit of U.S. Provisional Application titled, “TECHNIQUES FOR PERFORMING DEBANDING USING FILM GRAIN SYNTHESIS,” filed on Apr. 2, 2025, and having Serial No. 63/782,472 and claims the benefit of U.S. Provisional Application titled, “TECHNIQUES FOR PERFORMING DEBANDING USING FILM GRAIN SYNTHESIS,” filed Apr. 4, 2025, and having Serial No. 63/783,893. The subject matter of these related applications is hereby incorporated herein by reference.

### BACKGROUND

### Field of the Various Embodiments

Embodiments of the present disclosure relate generally to computer science, video streaming, and video processing technologies. More specifically, the disclosed techniques disclosed relate to performing debanding using film grain synthesis.

### Description of the Related Art

Modern streaming services provide audiovisual content to endpoint devices via a network. To conserve network bandwidth and maintain high network throughput, the audiovisual content is typically encoded into a compressed form prior to transmission across the network. Some media titles include visual characteristics or artifacts that can complicate the encoding process and lead to low-efficiency compression. One such visual characteristic is known as “film grain” and another characteristic is known as “banding”.

Film grain is a subtle visual distortion resembling the visual qualities of physical film once used in traditional cinema. Film grain frequently appears in media titles that are digital representations of older physical films or in modern films that are intended to appear older. When film grain is an intentional visual characteristic, preservation during the encoding and subsequent decoding process should occur to the extent possible. However, banding can result from decoding, especially in frames of video where film grain was removed and/or added. Banding can refer to a series or group of pixels that appear similar in color and/or brightness, despite corresponding portions of the original film or file not having such characteristics. In other words, banding can reflect a loss in quality during video playback, despite efforts to preserve quality during encoding and decoding.

Conventional approaches to preserving film grain may not produce consistent results or reliably prevent banding. When the process fails for a given media title, the media title as a whole may not be efficiently or accurately encoded to a compressed size. Consequently, transmitting media titles with film grain often utilizes excessive network bandwidth and reduces network throughput.

As the foregoing illustrates, what is needed in the art are more effective techniques for performing debanding using film grain synthesis.

### SUMMARY

One embodiment sets forth a technique for reducing visibility of banding artifacts in a video stream by performing steps of receiving a video stream; generating, for at least one video frame of the video stream, an offset value corresponding to a banding artifact present in the video stream; generating modified noise based on the offset value; and adding the modified noise to the video stream to generate an output video stream.

Another embodiment sets forth a technique for reducing visibility of banding artifacts in a video stream by performing steps of receiving a video stream; filtering a portion of the video stream with a banding artifact; generating, for at least one video frame of the video stream, an offset value based on a difference between a filtered portion of the video stream and the portion of the video stream; generating modified noise for the at least one video frame based on the offset value; and adding the modified noise to the video stream to generate an output video stream.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques over the prior art is that the disclosed techniques implement adaptive restoration of film grain in portions of video streams. Conventional methods rely on non-adaptive filtering methods. Such approaches may remove banding but simultaneously destroy genuine, subtle image details and textures. By generating an adaptive offset, quantization errors can be corrected to effectively dissolve visible bands while better preserving the true nature of an original video’s gradients and textures.

Another technical advantage of the disclosed techniques over the prior art is the disclosed techniques improve compression rates without compromising quality of viewing experience. Prior compression schemes dedicate significant bitrate to flat regions to prevent noticeable banding, or alternatively, resort to coarse smoothing making natural scenes appear artificial. The disclosed methods circumvent this problem by creating modified noise capable of actively concealing visible artifacts resulting from high compression. Such improvements allow encoders to operate at much lower bitrates and achieve substantial savings in network bandwidth that remain otherwise unattainable with earlier artifact concealment strategies.

Another technical advantage of the disclosed techniques over the prior art is the disclosed techniques integrate artifact concealment with natural film grain without sacrificing natural textures for less banding artifacts. By using natural film grain as a mechanism for concealment, a final video output stream will maintain a more organic, textured appearance compared to excessively artificial methods for debanding.

These technical advantages represent one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a conceptual illustration of an architecture and an informational flow implemented by the content server of FIG. 1, according to various embodiments.

FIG. 3 is a conceptual illustration of an architecture and an informational flow implemented by the content server of FIG. 1, according to various embodiments.

FIG. 4 is a conceptual illustration of an architecture and an informational flow implemented by the endpoint device(s) of FIG. 1, according to various embodiments.

FIG. 5 is a conceptual illustration of an architecture and an informational flow implemented by the content server(s) and/or endpoint device(s) of FIG. 1, according to various embodiments.

FIG. 6 is a conceptual illustration of an architecture and an informational flow implemented by the content server(s) and/or endpoint device(s) of FIG. 1, according to various embodiments.

FIG. 7A illustrates a view of a causal pixel neighborhood used for gradient-based offset calculation, according to various embodiments.

FIG. 7B illustrates a diagram of a counter-based thresholding for banding detection, according to various embodiments.

FIG. 8 illustrates a view of a causal pixel neighborhood used for a recurrent weighted average offset calculation, according to various embodiments.

FIG. 9 illustrates a view of a non-causal pixel neighborhood including a look-ahead area for offset calculation, according to various embodiments.

FIG. 10 illustrates a view of a cross-shaped filter for offset calculation, according to various embodiments.

FIG. 11 illustrates a view of an expanded cross-shaped filter including diagonal pixels, according to various embodiments.

FIG. 12 illustrates a view of a rectangular-shaped filter window for offset calculation, according to various embodiments.

FIG. 13 illustrates a block diagram of a pixel block and padding for an integral image calculation, according to various embodiments.

FIG. 14 illustrates a block diagram of a pixel block and summed-area table for a rectangular filter operation, according to various embodiments.

FIG. 15 illustrates a block diagram of sequential video blocks processed across a block boundary, according to various embodiments.

FIG. 16 illustrates a method for reducing banding artifacts in a video stream, according to various embodiments.

FIG. 17 illustrates a method for filtering and reducing banding artifacts in a video stream, according to various embodiments.

FIG. 18 is a more detailed illustration of a computing device for implementing the functionalities of the entities illustrated in FIGS. 1-6, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Film grain represents a subtle visual distortion mirroring the characteristics of the physical film employed in traditional cinema. Film grain frequently appears in media titles serving as digital representations of older physical films or in modern films intending to appear from an earlier era. As film grain generally constitutes a desirable and/or intentional visual characteristic, the film grain should be preserved during the encoding and subsequent decoding process to the greatest extent possible. Accordingly, various techniques have been developed for removing film grain prior to encoding and then reintroducing the film grain once the encoded video has been decoded. However, one drawback associated with conventional approaches to preserving film grain involves the unreliable nature of removing and later reintroducing the film grain, which occasionally leads to failure. When such processes fail for a given media title, achieving an efficient encoding to a compressed size becomes unattainable. Consequently, transmitting media titles with film grain frequently utilizes excessive network bandwidth and reduces network throughput.

Accordingly, the disclosed techniques address the aforementioned issues by employing a video encoding pipeline with a film grain processing service (FGPS) configured to process a source video to generate a film-grain synthesis (FGS) video. The FGS video can specify different portions of a source video to be encoded and decoded using film grain synthesis techniques, as well as other portions of the source video not requiring such encoding and decoding. The FGPS divides the source video into different segments having a given duration. The FGPS then attempts to denoise one or more portions of each segment to remove film grain characteristics and also attempts to model the film grain characteristics of each segment. The FGPS evaluates whether the denoising and/or modeling operations are successful and then generates film grain data, such as a film grain table.

For a given portion of the source video, a corresponding film grain table can include film grain model parameters for reproducing film grain included in the given portion. The FGPS then generates, based on the film grain table, the FGS video. The FGS video can include a sequence of pointers indicating, for each portion of the source video, either a corresponding portion of the source video or a corresponding portion of denoised video. In some instances, during encoding, an encoder can use the FGS video to generate an encoded video to include some segments taken directly from the source video and other segments generated by the denoising operation. The encoded video can also include a film grain table. During streaming, an endpoint device can decode the encoded video and then use the film grain table to reproduce the film grain characteristics removed via the denoising operation, and then reintroduce the film grain characteristics into the denoised segments.

At least one technical advantage of the disclosed techniques over the prior art is that the disclosed techniques implement adaptive restoration of film grain in portions of video streams. Conventional methods rely on non-adaptive filtering methods. Such approaches may remove banding but simultaneously destroy genuine, subtle image details and textures. By generating an adaptive offset, quantization errors can be corrected to effectively dissolve visible bands while better preserving the true nature of an original video’s gradients and textures.

Another technical advantage of the disclosed techniques over the prior art is the disclosed techniques improve compression rates without compromising quality of viewing experience. Prior compression schemes dedicate significant bitrate to flat regions to prevent noticeable banding, or alternatively, resort to coarse smoothing making natural scenes appear artificial. The disclosed methods circumvent this problem by creating modified noise capable of actively concealing visible artifacts resulting from high compression. Such improvements allow encoders to operate at much lower bitrates and achieve substantial savings in network bandwidth that remain otherwise unattainable with earlier artifact concealment strategies.

Another technical advantage of the disclosed techniques over the prior art is the disclosed techniques integrate artifact concealment with natural film grain without sacrificing natural textures for less banding artifacts. By using natural film grain as a mechanism for concealment, a final video output stream will maintain a more organic, textured appearance compared to excessively artificial methods for debanding.

These technical advantages represent one or more technological advancements over prior art approaches.

### System Overview

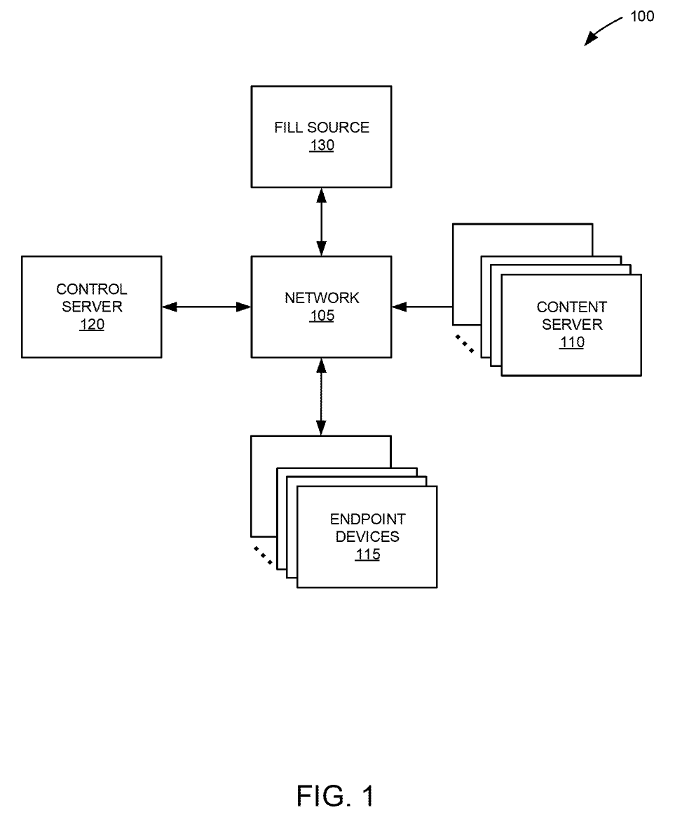

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform having network connectivity and is capable of presenting content, such as text, images, video, and/or audio content, to a user.

Each content server 110 may include a web-server, a database, and a server application configured to communicate with the control server 120 to determine the location and availability of various files being tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

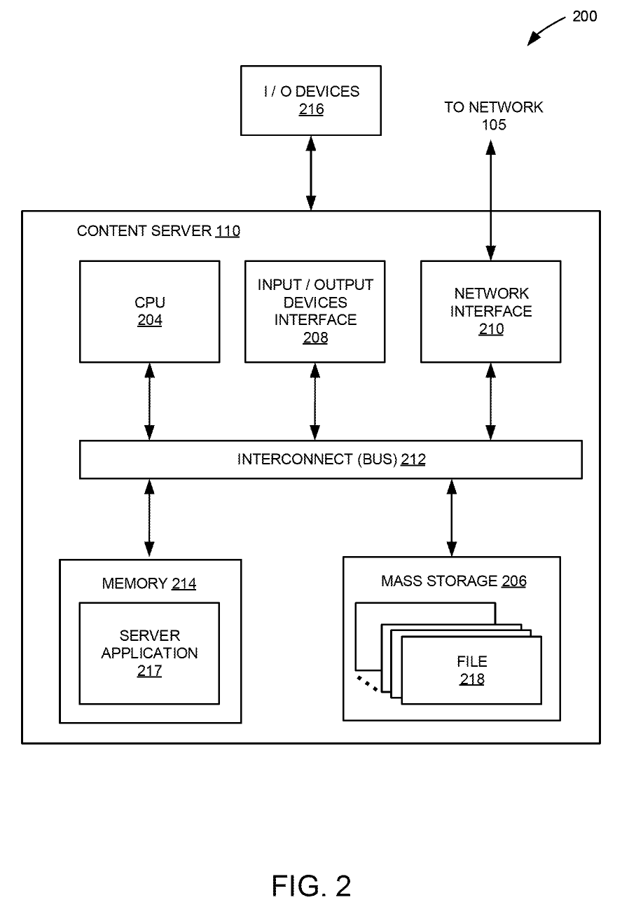

FIG. 2 is a block diagram of a content server 110 implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect (bus) 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

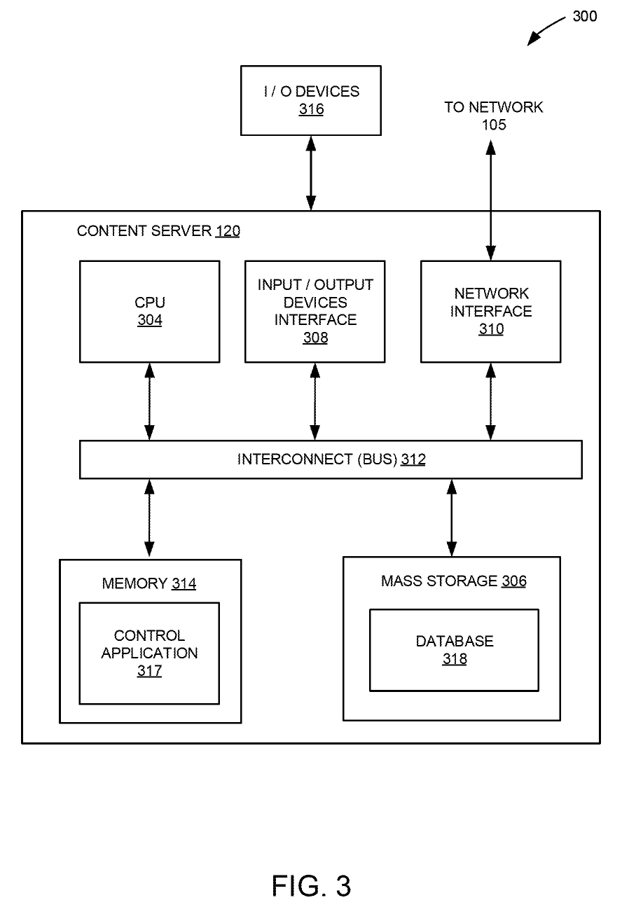

FIG. 3 is a block diagram of a control server 120 implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect (bus) 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 to compress files 218 prior to transmission to an endpoint device 115. Alternatively, and without limitation, files stored in fill source 130 could be compressed, via an encoding pipeline within system 100, prior to storage.

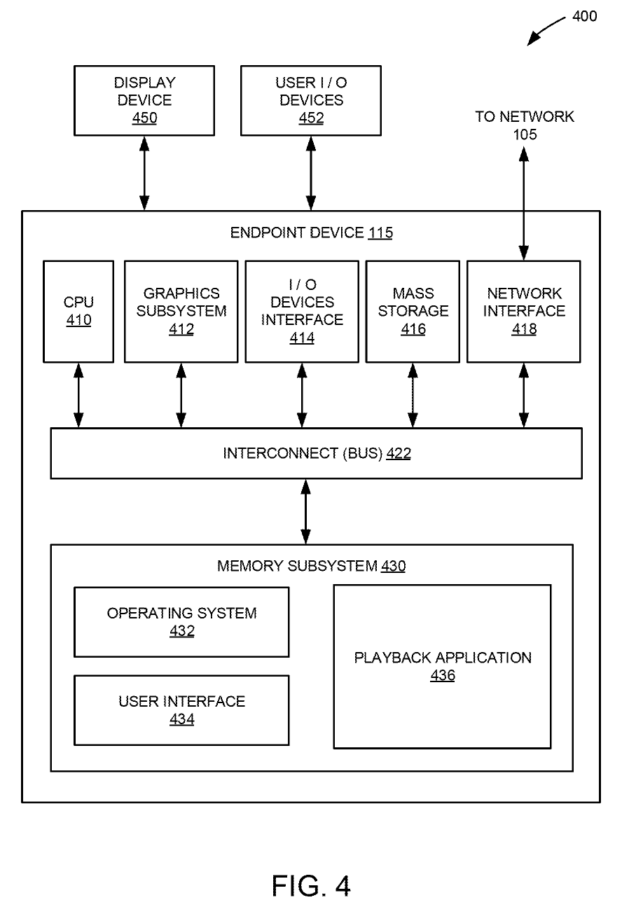

FIG. 4 is a block diagram of an endpoint device 115 implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect (bus) 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art for displaying video frames and generating an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard or other protocol. The network interface 418 is coupled to the CPU 410 via the interconnect 422.

In some embodiments, the memory subsystem 430 includes programming instructions and application data comprising an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline for decoding compressed content prior to display via display device 450.

### Performing Debanding Using Film Grain Synthesis

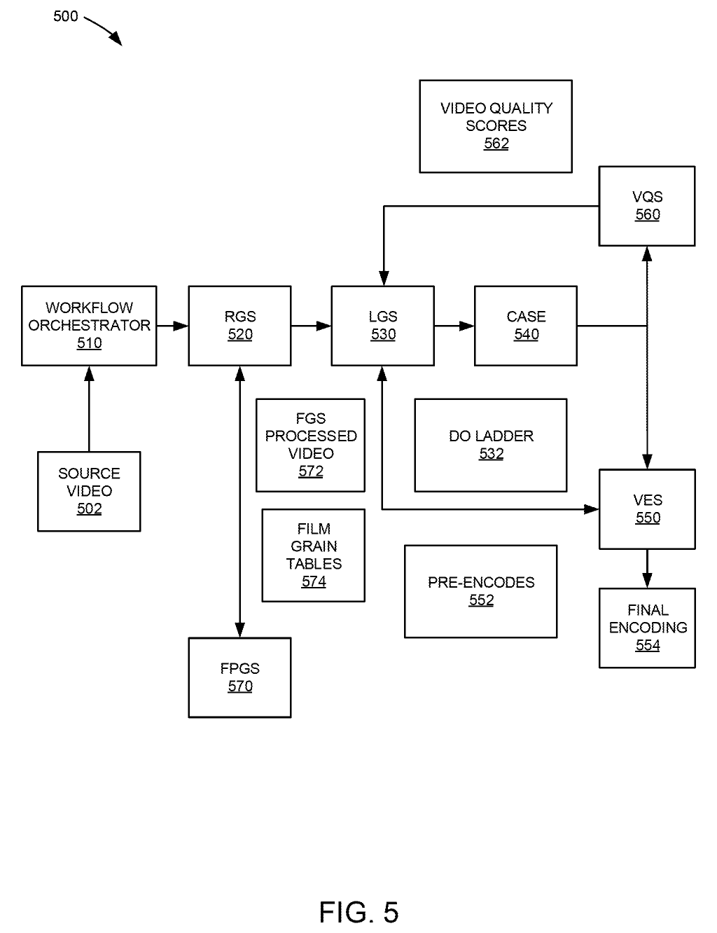

FIG. 5 illustrates a system 500 or pipeline for synthesizing and integrating film grain into a video stream to reduce banding artifacts without sacrificing aesthetic qualities of an original source video. The system 500 can effectuate initial processing of an original source video 502 to identify undesirable compression artifacts, specifically color or luma banding, and generate modified noise to restore the film grain texture and actively conceal visual imperfections. This process can be governed by a framework optionally making decisions on a frame-by-frame basis, ensuring the advanced synthesis techniques are applied where effective, and so as to not degrade visual quality.

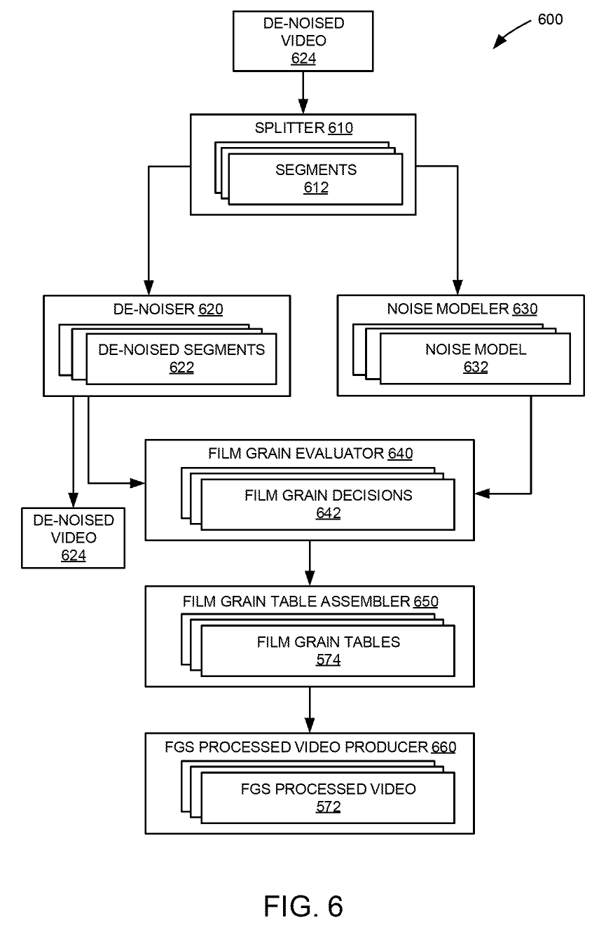

The system 500 is managed by a workflow orchestrator 510, which can coordinate ingestion of an original source video 502. The workflow orchestrator 510 can engage a Film-Grain Processing Service (FGPS) 570 to analyze and prepare the source video 502 for synthesis-based encoding. The FGPS 570 can provide an FGS video 572 and a set of film grain tables 574, as illustrated in FIG. 6. The FGPS 570 can perform primary analysis and modeling by initially using a splitter 610, which can divide the source video into discrete temporal segments 612, optionally of a fixed duration (e.g., N-seconds), to organize by shots or frames. Once segmented, the data can flow to two parallel modules: a de-noiser 620 and a noise modeler 630. The de-noiser 620 applies advanced filtering techniques, such as a Gaussian blur, a bilateral filter, or non-local means, to remove the original film grain and other high-frequency noise from each segment, producing clean, denoised segment(s) 622 of the video. A denoised video 624 can serve as a compressible base layer for shots where synthesis is ultimately enabled.

Simultaneously, the de-noised segments 620 can be fed into the noise modeler 630. The noise modeler 630 can perform a noise estimation operation, using algorithms such as, but not limited to, the Yule Walker algorithm, to create a mathematical model of the film grain removed by the de-noiser 622. In some implementations, the noise modeler 630 can capture a characteristic texture of a source video 502. The noise modeler 630 may also detect and model banding artifacts. The noise modeler 630 can analyze the segments to identify groups of pixels exhibiting a threshold degree of banding, which is typically characterized by a subtle but visible step-like transition in what should be a smooth color or brightness gradient. Such detection can be based on measuring the difference between adjacent pixel luma or chroma values.

When banding is detected, or a threshold amount of banding is detected, the noise modeler 630 generates an offset value to counteract the detected banding. The calculation of such an offset can follow one or more methodologies. For example, a non-causal or block-based approach can involve analyzing a small lookahead area of pixels. Such a method may involve applying a filter (e.g., Gaussian, bandpass, or bilateral) to a rectangular portion of the video frame to create a smooth version of the gradient. The offset value is then calculated as the difference between the filtered portion and the original, banded portion to ensure the correction is context-aware and preserves overall image quality by limiting application to smoother areas.

As another methodology, pixels can be analyzed in a sequential relationship. This can involve estimating horizontal and vertical gradients by analyzing consecutive samples with similar values and/or using a recurrent weighted average of neighboring pixels to determine an appropriate offset for a current pixel. For example, this methodology can involve counting a number of consecutive past samples having the same or similar luma value (e.g., within a threshold). Counters can be maintained for a current run of similar pixels and a preceding run of similar pixels. The size of a counter can indicate a length of the previous band, which can be used to calculate the gradient and subsequent offsets for the pixels in the current band. For example, if a previous counter was 8, the algorithm will generate a series of decreasing offsets (e.g., 7/8, 6/8, 5/8...) for the pixels in the current band to create a smooth ramp between the two bands. Separate horizontal and vertical gradient offsets can be calculated and then combined (e.g., averaged) to produce a final offset. If the luma value of a new pixel differs from the previous luma value by more than a threshold value, indicating the end of a smooth band, and resulting in the counters being reset to zero.

In some implementations, pixels can be processed using estimates of the average sample value in a region using a recurrent weighted average in both the horizontal and vertical directions. The weighted average can operate as a running sum being continuously updated as long as the luma value of the current pixel remains within a threshold of previous ones. If a pixel value is found to change abruptly, the running sum can be reset, and a final offset value can then be derived from a difference between the current pixel's value and the calculated recurrent average.

In some implementations, a rectangular-shaped filter can be utilized to generate a banding offset. Such a method can rely on a pre-calculated integral image or summed-area table, with each cell storing a sum of all pixels to the left and above. Such a structure can allow the grain and banding modeler 630 to calculate the sum of all pixels within any rectangular filter window (e.g., a 5x5 area) with a limited number of arithmetic operations, thereby reducing processing times regardless of filter size. For each pixel being processed, the integral image can be used to find the average pixel value within a rectangular filter window centered on a respective pixel. The offset can then be calculated as a difference between such a local average and the pixel's original value. Such an offset can then be scaled or limited to a maximum and minimum value to ensure any modifications stay within a limited boundary.

In some implementations, the output of the noise modeler 630 can be a noise model 632 containing not only the parameters to describe the original film grain but also specific offset values needed to mitigate detected banding. The outputs from the de-noiser 620 and the noise modeler 630 are passed to the film grain evaluator 640, which can evaluate whether the denoising operation was successful. Such evaluation can occur by, for instance, comparing the denoised segment to the original to ensure pixel values have not diverged significantly or by checking if a quality metric such as Peak Signal-to-Noise Ratio (PSNR) or Video Multimethod Assessment Fusion (VMAF) falls below a predefined threshold. In some implementations, the film grain evaluator 640 can determine whether employing the generated noise model 632 causes a non-transient execution error, a failure to converge within a time limit, or an undesirable output, such as a calculated grain variance being too high or a banding offset being unstable across resolutions. If any of these operations-denoising, grain modeling, or banding modeling-is deemed unsuccessful for one or more portions or frames of a video, the film grain evaluator 640 can determine one or more film grain decisions 642. For instance, the film grain evaluator 640 can disable film grain synthesis and banding reduction for an entire video portion and/or set of frames, across all potential resolutions. Such decisions can encourage consistent viewing experiences while preventing scenarios where the film grain texture might appear or disappear as the streaming resolution changes mid-shot.

For each frame or video portion approved for synthesis, a film grain table assembler 650 can process each corresponding noise model 632 and compile parameters into film grain table(s) 574. Such tables can thus contain parameters such as grain strength, seed, and/or distribution models, and also offset values for banding reduction. For video portions where synthesis is disabled, no table may be generated. In some implementations, an FGS processed video producer 660 can thereafter generate FGS video 572. In some implementations, the FGS video 572 can include a metadata structure containing an array of pointers. For each portion of video, frame, or other shot, a pointer directs the subsequent encoding process to the correct source: either the corresponding shot in the de-noised video 624 if synthesis was enabled, or the shot in the original source video 502 if synthesis was disabled. Such a pointer-based approach can preserve significant storage space by avoiding the need to generate a new, hybrid video file.

In reference to FIG. 5, the workflow orchestrator 510 can proceed with any additional encoding stages. For example, a recipe generation service (RGS) 520 and ladder generation service (LGS) 530 can utilize the FGS video 572 to formulate an optimal encoding strategy and/or generate a dynamically-optimized (DO) ladder 532 depending on complexity of the video. The video encoder service (VES) 550 can then perform any final encoding using the pointers referenced in the FGS video 572. The VES can encode the denoised frames for approved shots and/or video portions by accessing the corresponding film grain tables 574 and embedding parameters from such tables, including the banding offsets, into the frame headers of the final encoded bitstream 554.

In some implementations, such a final stage can optionally occur at a client-side device during playback and/or just before playback. When the decoder processes a frame from a video portion where synthesis was enabled, the decoder can first decode the clean, denoised video. The decoder then extracts the rich set of parameters from a film grain table of the frame header. Using the parameters, the decoder generates the modified noise. Such an approach can result in a newly synthesized texture (e.g., not a default texture), such as white Gaussian noise with a non-zero mean, that is specifically shaped and biased by the offset value. This modified noise is then applied selectively to the luma and/or chroma components of the video, and/or to any other video components. The result is a final output frame where the banding artifacts are effectively masked by the intelligently structured noise, and the intended film grain texture is restored, delivering a high-quality viewing experience from a highly compressed video stream.

### Pixel Processing for Banding Offset Calculation

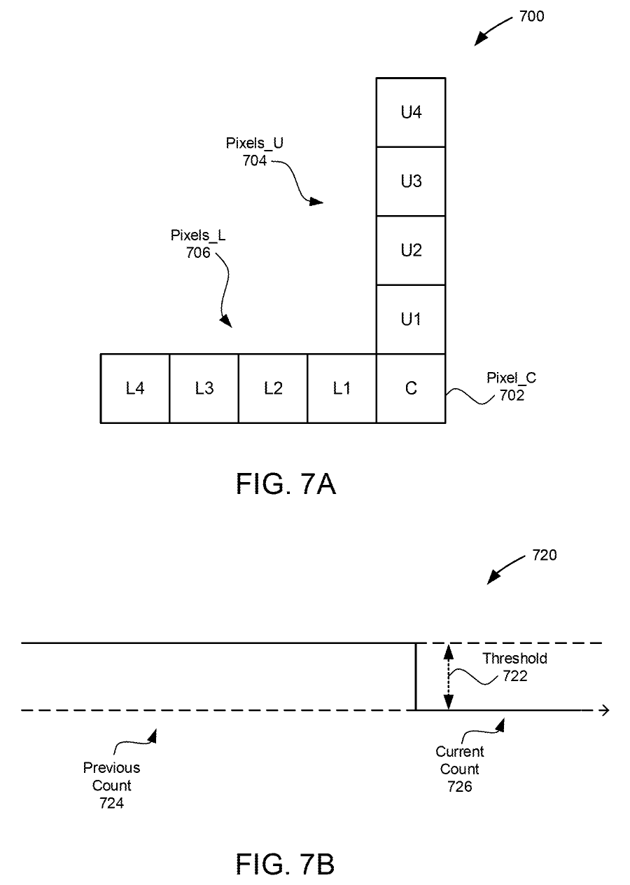

FIG. 7A illustrates a view 700 of a causal neighborhood of pixels used for banding artifact analysis. This arrangement is utilized by the grain and banding modeler 630 to perform a causal offset calculation. For example, the grain and banding modeler 630 can analyze Pixels_L 706 and Pixels_U 704 to estimate horizontal and vertical gradients for calculating an offset for Pixel_C 702. FIG. 7B illustrates a diagram 720 showing the relationship between a previous count 724 and a current count 726 of lumina values compared to a threshold 722. The diagram 720 shows a non-limiting example of a counter-based logic implemented by the grain and banding modeler 630 to determine a length of uniform bands during a gradient estimation process.

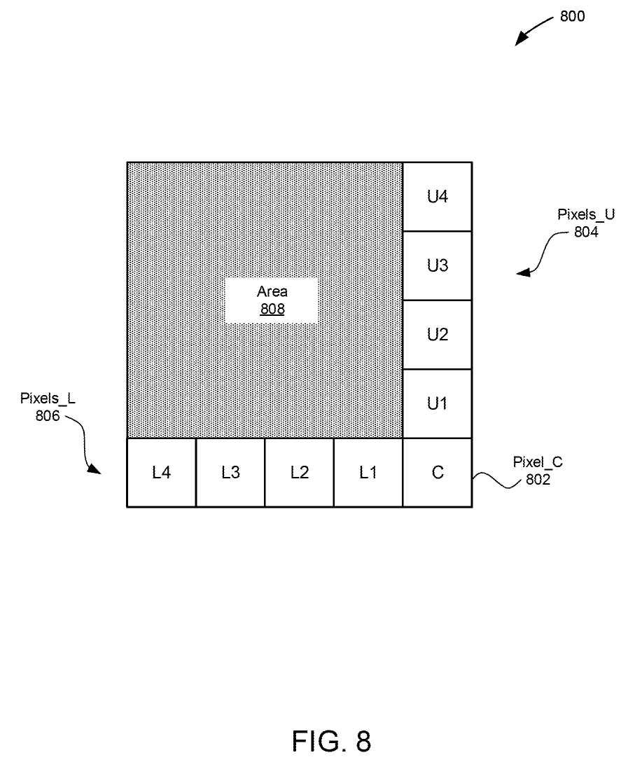

FIG. 8 illustrates a view 800 of another causal pixel neighborhood. FIG. 8 can be utilized by the grain and banding modeler 630 to perform a recurrent weighted average offset calculation. The grain and banding modeler 630 can use the values from the entire causal neighborhood shaded area 808, which can include pixels above (Pixels_U 804) and pixels to the left (Pixels_L 806), to compute a running weighted average, which is then compared against Pixel_C 802 to generate a banding offset.

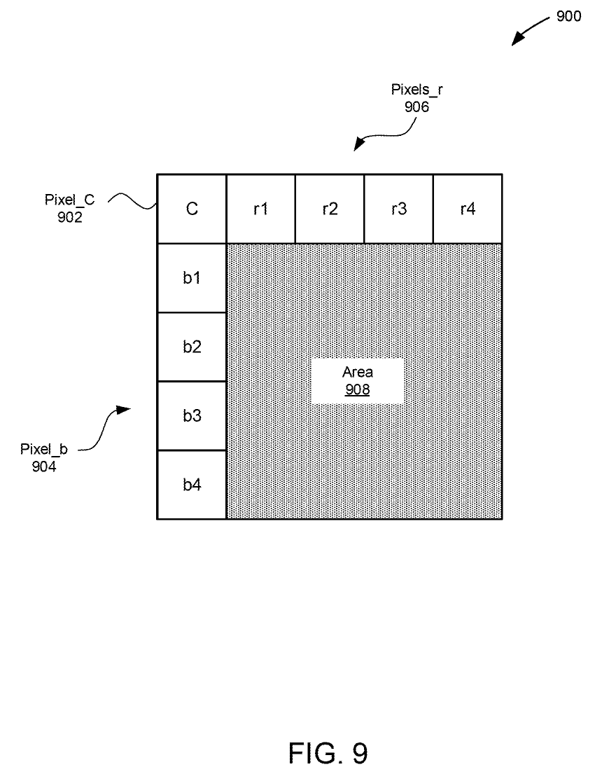

FIG. 9 illustrates a view 900 of a non-causal pixel neighborhood. This non-causal relationship can be utilized by the grain and banding modeler 630 to perform a block-based, non-causal offset calculation. These algorithms may sample a look-ahead area 908, which can include pixels to the right (Pixels_R 906) and below (Pixel_B 904) the current Pixel_C 902 to determine an offset value, such as when using a rectangular filter.

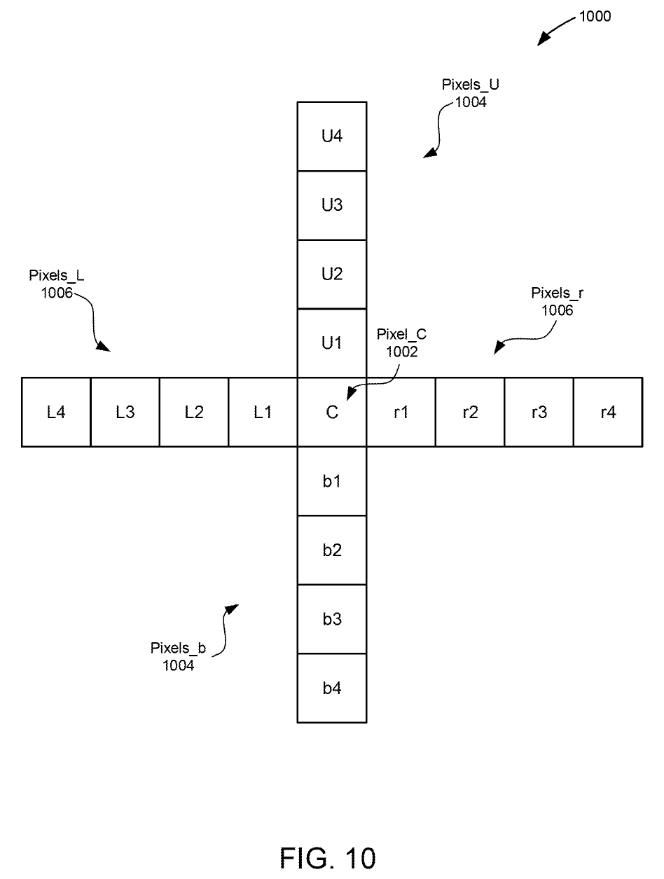

FIG. 10 illustrates a view 1000 of a pixel neighborhood forming a filter used by the grain and banding modeler 630 to execute a rectangular-shaped filter operation. The grain and banding modeler 630 calculates an average value from a neighborhood (including causal Pixels_U 1004 and Pixels_L 1006, and non-causal Pixels_b 1004 and Pixels_r 1006) to determine an estimated offset value for Pixel_C 1002.

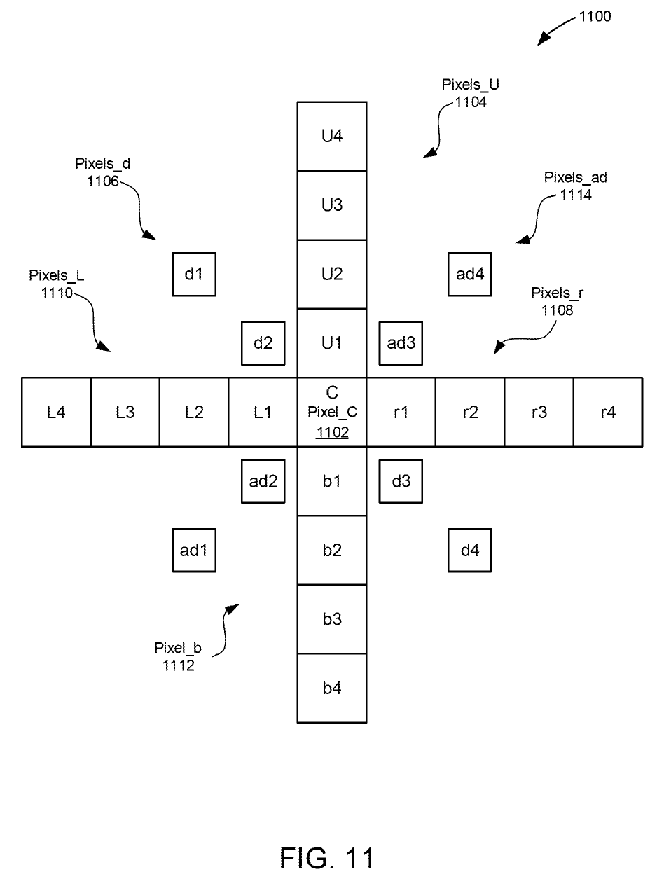

FIG. 11 illustrates a view 1100 of an expanded pixel neighborhood representing a filter shape for an operation executed by the grain and banding modeler 630. By sampling this wide array of causal, non-causal, and diagonal pixels, the grain and banding modeler 630 can compute an accurate estimated sample value for determining an estimated offset value for Pixel_C 1102. For example, an average value can be calculated for a neighborhood comprising the causal Pixels_U 1104 and Pixels_L 1110, and one or more diagonal Pixels_d 1106, and comprising non-causal Pixels_r 1108 and Pixels_b 1112, and one or more other diagonal Pixels_ad 1114.

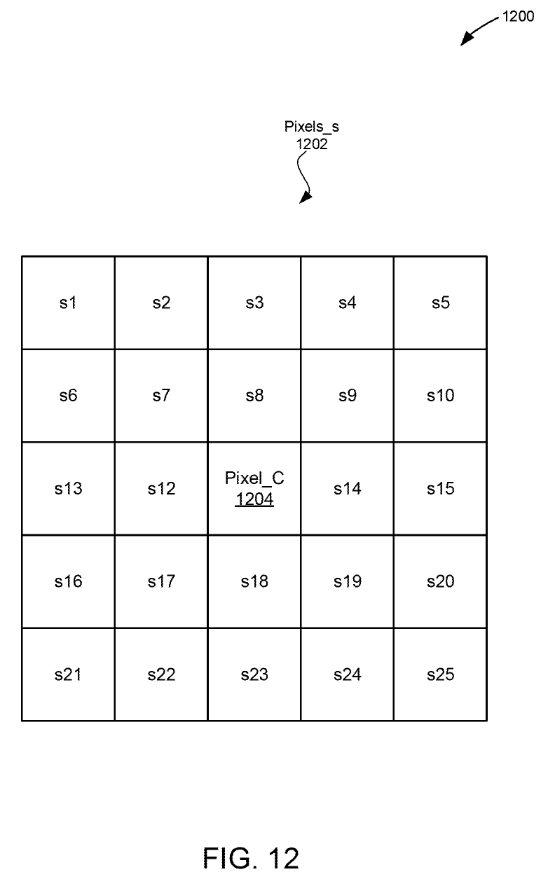

FIG. 12 illustrates a view 1200 of a rectangular-shaped filter window, such as a 5 x 5 grid, centered at Pixel_C 1204. This window of pixels is processed by the grain and banding modeler 630 to calculate an average value of all pixels in this window (including Pixels_s 1202) to generate an estimated value for Pixel_C 1204, with the offset being the difference between this average and the original value. In some implementations, filter window can be diamond-shaped or other shape appearing rotated from the grid in FIG. 12.

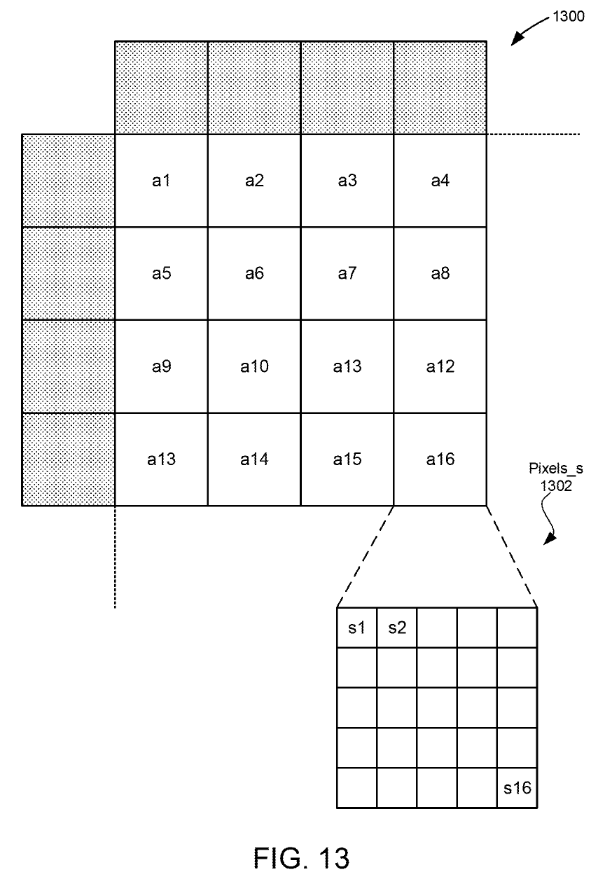

FIG. 13 illustrates a view 1300 of a pixel block of Pixels_s 1302 prepared by the grain and banding modeler 630 to perform rectangular-shaped filtering. The shaded padding samples can be adjacent blocks provided to create an integral image. The integral image is then utilized to calculate an average for near an edge of the pixel block, such as pixel a16.

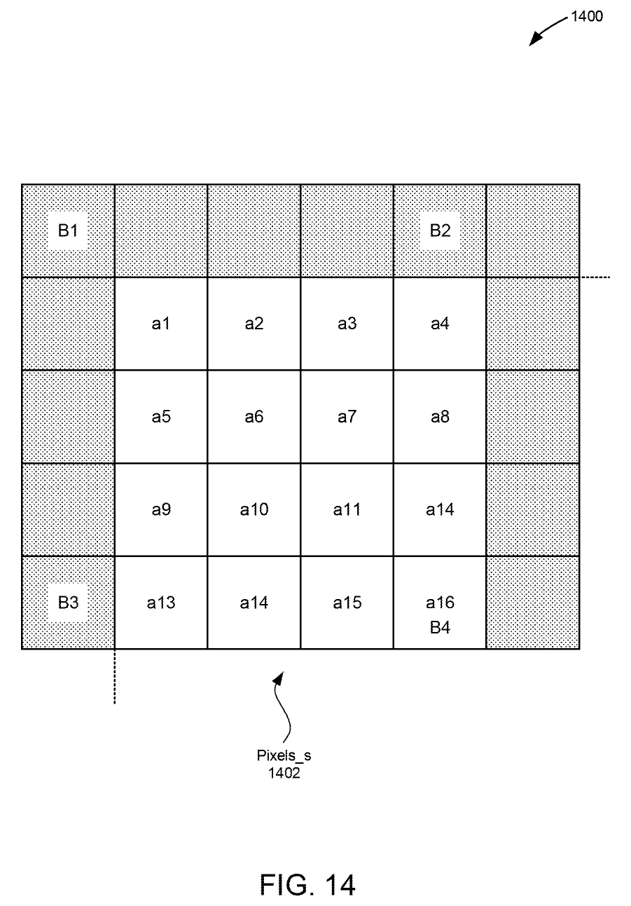

FIG. 14 illustrates a view 1400 of a pixel block of Pixels_s 1402 and filter neighborhood for processing by the grain and banding modeler 630. Corner blocks B1, B2, B3, and B4 represent query points in a summed-area table that the grain and banding modeler 630 can use to efficiently calculate the sum of all pixels within the Pixels_s 1402 block (e.g., sum = B1 + B4 - B2 - B3).

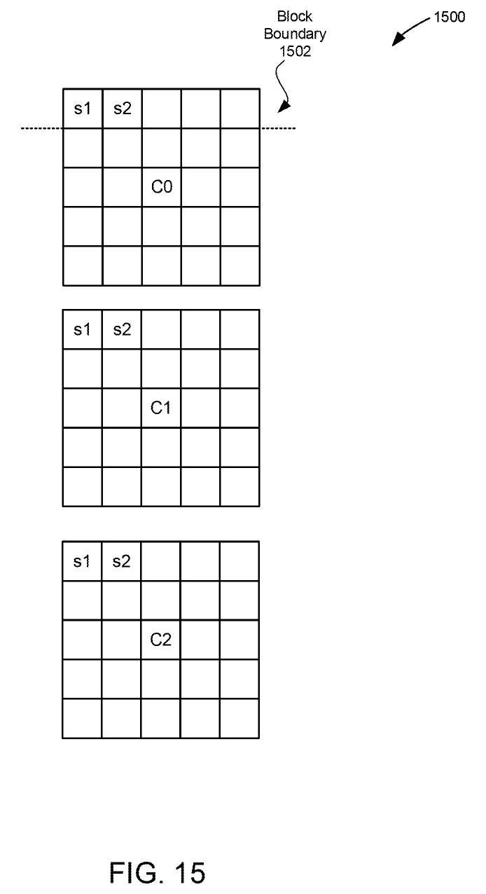

FIG. 15 illustrates a view 1500 of sequential pixel blocks processed by the FGPS 570. The splitter 610 from FIG. 6 can divide the source video into segments or blocks (referenced as C0, C1, C2). As the grain and banding modeler 630 processes these blocks sequentially, pixel data (such as s1, s2) can be stored from the last line of one block (e.g., containing C0) in a line buffer. The stored data can then be used by the grain and banding modeler 630 as causal “up” pixels when initially processing a first line of a subsequent block (containing C1) across the block boundary 1502.

### Offset Generation for Film Grain Synthesis

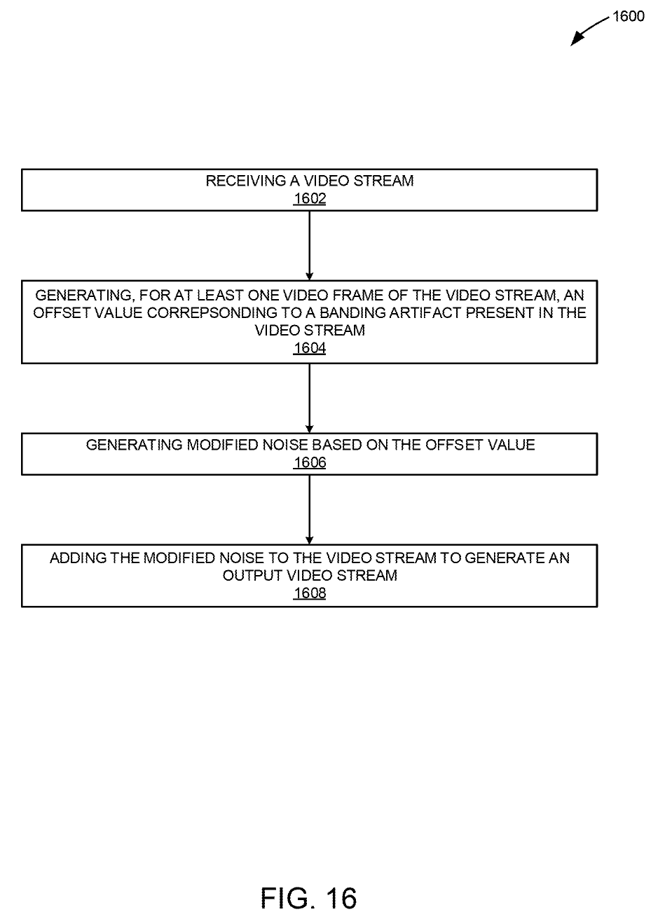

FIG. 16 illustrates a method 1600 for removing binding artifacts from a video stream, according to various embodiments. The method 1600 represents a content-adaptive technique for detecting specific visual characteristics indicative of banding caused by quantization error. As shown in FIG. 16, the method 1600 begins at step 1602, where a video stream is received by a content server (e.g., as described above in conjunction with FIGS. 1-6). The video stream may be received in a compressed format, such as H.264, HEVC, or AV1, and is typically decoded to uncompressed or partially uncompressed pixel data (e.g., YUV or RGB) before processing begins. In some embodiments, the content server can perform this processing offline prior to streaming, while in other embodiments, the processing can be performed in real-time as part of a Just-In-Time (JIT) packaging or transcoding pipeline. The specific components being processed, such as the luminance (luma) and chrominance (chroma) channels, can be selected based on the compression format and where the banding artifacts may be most visually pronounced.

At step 1604, the content server can generate, for at least one video frame or portion of the video stream, an offset value corresponding to a banding artifact present in the video stream (e.g., as described above in conjunction with FIGS. 1-6). Generation step 1604 can involve a detection process, which, in some implementations, includes traversing pixel data in one or more directions-horizontal (e.g., Pixels_L 706 of FIG. 7A), vertical (e.g., Pixels_U 704 of FIG. 7A), and/or diagonal-to count consecutive pixels having a difference in value (e.g., luma) below a specific, minimum threshold (e.g., threshold 722 of FIG. 7B). In some embodiments, a group of pixels can be processed to determine whether the uniformity of values of the group of pixels indicates a presence of a wide, flat band the viewer may perceive as an artifact. The resulting offset value may be a non-integer, sub-sample value, thereby ensuring subsequent correction can be applied without introducing new integer-quantization errors.

In some implementations, an offset value can be determined using a look-ahead feature (as shown in FIG. 9 with area 908) or pixel neighborhood (as shown in FIGS. 10 or 11), wherein subsequent frames are analyzed to predict the temporal stability of the banding artifact, allowing for smoother correction over time. The magnitude of an offset value may be directly correlated with the confidence for a severe banding artifact exists, thereby indicating a larger, flatter area detected results in a larger initial offset to maximize the concealment effect. At step 1606, the content server can generate modified noise based on the offset value (e.g., as described above in conjunction with FIGS. 1-6). The modified noise can be derived from a base noise sample, which in various embodiments may be synthetic white Gaussian noise, other synthetic noise, or sampled film grain data captured from various film stocks. The modification process can involve adding the sub-sample offset value to the base noise sample on a per-pixel, per-component basis. In certain implementations, the noise generator includes a module with varying the noise characteristics (e.g., size, intensity, color profile) spatially across the video frame, ensuring the modified noise effectively masks other spatially varying banding artifacts.

At step 1608, the content server can add the modified noise to the video stream to generate an output video stream (e.g., as described above in conjunction with FIGS. 1-15). Such an addition operation can be implemented using an arithmetic unit capable of handling the fractional nature of the modified noise before any final re-quantization to the output bit depth (e.g., 8-bit or 10-bit). This addition can be performed on a block-by-block basis, as illustrated by the sequential processing of blocks (e.g., C0, C1, C2) in FIG. 15. In some embodiments, the modified noise is selectively applied to a luma component, chroma component, and/or both, to achieve full color banding correction. For video content originally containing natural film grain or noise, the modified noise can be added to corresponding regions containing the natural film gran or noise, ensuring the original aesthetic is preserved while the artifact is simultaneously corrected. The output video stream can be rendered by an endpoint device with any banding artifacts being less apparent or completely removed relative to an original source video for the video stream. Such correction techniques represent significant technical advantages over prior art by addressing visual problems directly by breaking the quantization monotony, unlike simple blurring which sacrifices content definition and quality.

### Offset Generation with Pre-Filtering

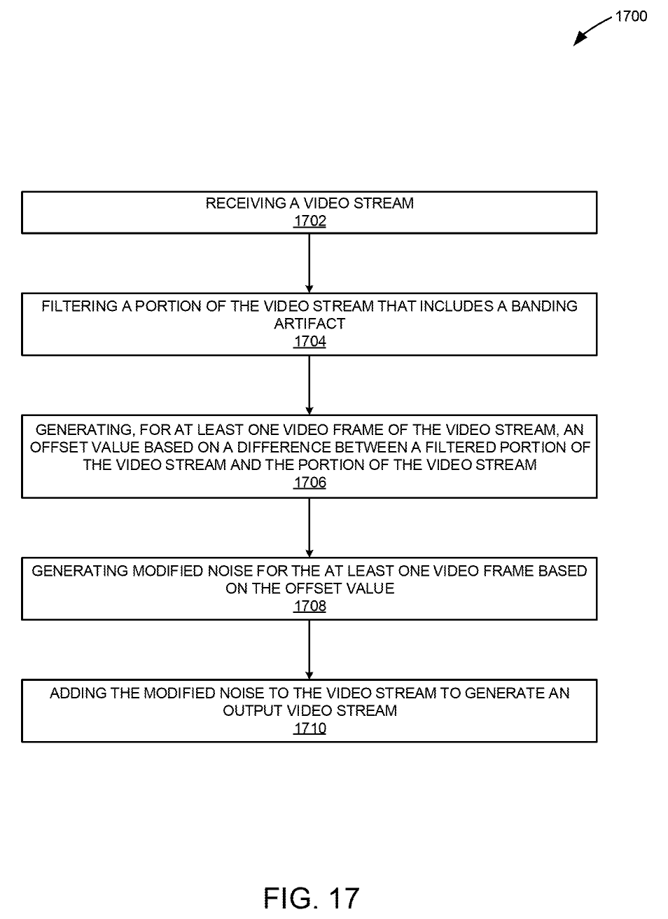

FIG. 17 illustrates a method 1700 for filtering and removing banding artifacts present in a video stream, according to various embodiments. The method 1700 offers an alternative, filter-based approach to generating the offset value and is advantageous when a precise, spatially varying offset is required to maintain the subtle local contrast within video frames. As shown in FIG. 17, the method 1700 begins at step 1702, where a content server can receive a video stream (e.g., as described above in conjunction with FIGS. 1-16). Similar to method 700, the input video stream is typically decoded to a working pixel space, which allows for per-component manipulation of luma and/or chroma data.

At step 1704, the content server can filter a portion of the video stream having a banding artifact (e.g., as described above in conjunction with FIGS. 1-15). For example, the content server can select an edge-preserving filter such as a bilateral filter or adaptive Gaussian filter. The use of a bilateral filter can weigh pixel contributions based on both spatial distance and photometric distance (e.g., intensity similarity). In some implementations, filtering occurs on a two-dimensional portion of a single video frame, using a defined portion size (e.g., square or rectangular as in FIGS. 12, 13, or 14; or cross-shaped as in FIGS. 10 or 100), whereas in other implementations, filtering is performed across multiple video frames to improve the stability of the correction over time.

In some implementations, a decision to apply filtering to a video portion can be made based on a determined classification for the video portion, or an area or block within the video portion. Such selective filtering can preserve image details otherwise degraded when indiscriminate filtering is applied. In some implementations, a portion of a video can be classified as smooth or not smooth, so filtering can be applied to smooth areas. A determination of whether a video portion is smooth can be based on a mean, mean squared error (MSE), sum of squared differences (SSD), and/or any other classifying calculation. A threshold can then be determined for comparing to the calculated value, and the filtering can be applied when the threshold is satisfied (e.g., SSD is below a threshold value, thereby indicating a low variance and thus a smooth area). In some implementations, multiple classification values can be generated across areas of different sizes.

For example, a multi-scale approach can involve initially calculating an SSD for samples over an area (e.g., 16 x 16 samples) and comparing the calculated SSD to a threshold, providing a macro-level assessment of smoothness. Thereafter, SSDs for smaller sub-blocks (e.g., 8 x 8, or 4 x 4 as shown in FIG. 13 or FIG. 14) of the larger area can be calculated and compared to a finer threshold. Based on such comparisons, a final decision to apply the filter can be made either based on the larger SSD falling below a threshold, or based on a statistical analysis, such as a maximum allowed number of smaller sub-blocks exceeding respective thresholds. In some implementations, if the decision involves classification of a 16 x 16 sample area, computations required per individual sample are significantly reduced. To further optimize for reduced complexity, the smallest sub-block comparisons can be done for blocks of size 8 x 8, and/or any other block size for a video portion.

At step 1706, the content server can generate, for at least one video frame of the video stream, an offset value based on a difference between a filtered portion of the video stream and the portion (e.g., original or unfiltered portion) of the video stream (e.g., as described above in conjunction with FIGS. 1-6). Such a difference can be calculated on a pixel-by-pixel basis by subtracting the filtered value from the original value. FIG. 14 illustrates the components of this calculation, where the sum of a pixel block (e.g., Pixels_s 1402) can be found using the values from corner blocks (B1, B2, B3, B4) derived from an integral image. In some embodiments, an offset value map can be generated to represent where video components need restoration. In some embodiments where a threshold degree of banding is also determined, the offset value map can be limited to regions exhibiting the threshold degree of banding, thereby increasing computational efficiency by ignoring areas without artifacts.

At step 1708, the content server can generate modified noise for the at least one video frame based on the offset value (e.g., as described above in conjunction with FIGS. 1-15). The base noise, which may include white Gaussian noise with a non-zero mean, is adjusted according to the offset value map. Such modified noise is then applied to ensure the grain is not uniformly added but is instead adapted by the offset to counter the quantization errors in the original video source. At step 1710, the content server can add the modified noise to the video stream to generate an output video stream. This addition can be applied on a block-by-block basis, as illustrated by the sequential processing of blocks (e.g., C0, C1, C2) in FIG. 15. In some implementations, the modified noise is selectively applied to the luma and/or chroma components where the filtering and/or offset generation occurred. The output video stream can be rendered by an endpoint device with any banding artifacts being less apparent or completely removed relative to an original source video for the video stream.

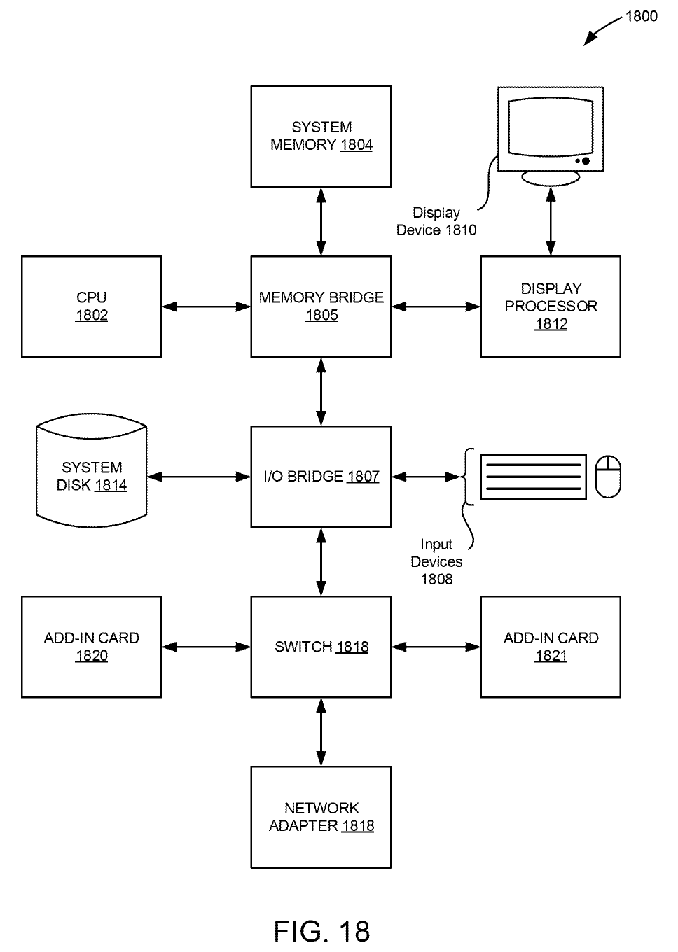

FIG. 18 is a more detailed illustration of a computing device implementing the functionalities of the entities illustrated in FIGS. 1-17, according to various embodiments. FIG. 9 in no way limits or is intended to limit the scope of the various embodiments. In various implementations, system 1800 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 1800 may be coupled together to practice one or more aspects of the various embodiments.

As shown, system 1800 includes a central processing unit (CPU) 1802 and a system memory 1804 communicating via a bus path having a memory bridge 1805. CPU 1802 includes one or more processing cores, and, in operation, CPU 1802 is the master processor of system 1800, controlling and coordinating operations of other system components. System memory 1804 stores software applications and data for use by CPU 1802. CPU 1802 runs software applications and optionally an operating system. Memory bridge 1805, which may be, e.g., a Northbridge chip, is connected via a bus or other communication path (e.g., a HyperTransport link) to an I/O (input/output) bridge 1807. I/O bridge 1807, which may be, e.g., a Southbridge chip, receives user input from one or more user input devices 1808 (e.g., keyboard, mouse, joystick, digitizer tablets, touch pads, touch screens, still or video cameras, motion sensors, and/or microphones) and forwards the input to CPU 1802 via memory bridge 1805.

A display processor 1812 is coupled to memory bridge 1805 via a bus or other communication path (e.g., a PCI Express, Accelerated Graphics Port, or HyperTransport link); in one embodiment display processor 1812 is a graphics subsystem having at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 1804.

Display processor 1812 periodically delivers pixels to a display device 1810 (e.g., a screen or conventional CRT, plasma, OLED, SED or LCD based monitor or television). Additionally, display processor 1812 may output pixels to film recorders adapted to reproduce computer generated images on photographic film. Display processor 1812 can provide display device 1810 with an analog or digital signal. In various embodiments, one or more of the various graphical user interfaces set forth in FIG. 3 are displayed to one or more users via display device 1810, and the one or more users can input data into and receive visual output from those various graphical user interfaces.

A system disk 1814 is also connected to I/O bridge 1807 and may be configured to store content and applications and data for use by CPU 1802 and display processor 1812. System disk 1814 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 1816 provides connections between I/O bridge 1807 and other components such as a network adapter 1818 and various add-in cards 1820 and 1821. Network adapter 1818 allows system 1800 to communicate with other systems via an electronic communications network, and may include wired or wireless communication over local area networks and wide area networks such as the Internet.

Other components (not shown), including USB or other port connections, film recording devices, and the like, may also be connected to I/O bridge 1807. For example, an audio processor may be used to generate analog or digital audio output from instructions and/or data provided by CPU 1802, system memory 1804, or system disk 1814. Communication paths interconnecting the various components in FIG. 18 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 1812 incorporates circuitry optimized for graphics and video processing, including, for example, video output circuitry, and constitutes a graphics processing unit (GPU). In another embodiment, display processor 1812 incorporates circuitry optimized for general purpose processing. In yet another embodiment, display processor 1812 may be integrated with one or more other system elements, such as the memory bridge 1805, CPU 1802, and I/O bridge 1807 to form a system on chip (SoC). In still further embodiments, display processor 1812 is omitted and software executed by CPU 1802 performs the functions of display processor 1812.

Pixel data can be provided to display processor 1812 directly from CPU 1802. In some embodiments, instructions and/or data representing a scene are provided to a render farm or a set of server computers, each similar to system 1800, via network adapter 1818 or system disk 1814. The render farm generates one or more rendered images of the scene using the provided instructions and/or data. Such rendered images may be stored on computer-readable media in a digital format and optionally returned to system 1800 for display. Similarly, stereo image pairs processed by display processor 1812 may be output to other systems for display, stored in system disk 1814, or stored on computer-readable media in a digital format.

Alternatively, CPU 1802 provides display processor 1812 with data and/or instructions defining the desired output images, from which display processor 1812 generates the pixel data of one or more output images, including characterizing and/or adjusting the offset between stereo image pairs. The data and/or instructions defining the desired output images can be stored in system memory 1804 or graphics memory within display processor 1812. In an embodiment, display processor 1812 includes 3D rendering capabilities for generating pixel data for output images from instructions and data defining the geometry, lighting shading, texturing, motion, and/or camera parameters for a scene. Display processor 1812 can further include one or more programmable execution units capable of executing shader programs, tone mapping programs, and the like.

Further, in other embodiments, CPU 1802 or display processor 1812 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 1802, display processor 1812, or one or more other processing devices or any combination of these different processors.

CPU 1802, render farm, and/or display processor 1812 can employ any surface or volume rendering technique known in the art to create one or more rendered images from the provided data and instructions, including rasterization, scanline rendering REYES or micro polygon rendering, ray casting, ray tracing, image-based rendering techniques, and/or combinations thereof and any other rendering or image processing techniques known in the art.

In other contemplated embodiments, system 1800 may be a robot or robotic device and may include CPU 1802 and/or other processing units or devices and system memory 1804. In such embodiments, system 1800 may or may not include other elements shown in FIG. 18. System memory 1804 and/or other memory units or devices in system 1800 may include instructions for causing the robot or robotic device represented by system 900 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 1804 is connected to CPU 1802 directly rather than through a bridge, and other devices communicate with system memory 1804 via memory bridge 1805 and CPU 1802. In other alternative topologies display processor 1812 is connected to I/O bridge 1807 or directly to CPU 1802, rather than to memory bridge 1805. In still other embodiments, I/O bridge 1807 and memory bridge 1805 might be integrated into a single chip. The particular components shown herein are optional; for instance, any number of add-in cards or peripheral devices might be supported. In some embodiments, switch 1816 is eliminated, and network adapter 1818 and add-in cards 1820, 1821 connect directly to I/O bridge 1807.

In sum, the disclosed techniques reduce banding artifacts apparent in video streams through noise or film grain synthesis based on generated offset values. The techniques involve segmenting video content into shots or frames to analyze whether the shots or frames exhibit a certain degree of banding. In some embodiments, an offset value can be determined based on video portions determined to exhibit banding artifacts and/or may undergo remedial actions to reduce the banding artifacts. In other embodiments, an offset value can be determined at least partially on a look-ahead basis, where frames or video portions subsequent in time are considered when determining an offset value. The offset value compensates for subsequent changes to video content and/or banding artifacts as a result.

The disclosed techniques can also employ filtering of video portions or frames as part of determining offset values. For example, a portion of an original video frame can undergo smoothing or another type of filtering. An offset value can then be generated based on differences between the original portion and the filtered portion of the video frame. The offset value can compensate for changes caused by filtering being otherwise implemented by, for example, a client application and/or endpoint device.

When offset values are generated for a video stream, noise can be added to the video stream by adjusting a noise model according to the offset values. In some embodiments, model parameters for generating modified noise for a video stream can be stored as metadata (e.g., a table of model parameters) in association with the video stream. The metadata can then be utilized by an endpoint device or application to reproduce the modified noise for reducing banding artifacts, thereby avoiding compression and decompression of the modified noise.

At least one technical advantage of the disclosed techniques over the prior art is that the disclosed techniques implement adaptive restoration of film grain in portions of video streams. Conventional methods rely on non-adaptive filtering methods. Such approaches may remove banding but simultaneously destroy genuine, subtle image details and textures. By generating an adaptive offset, quantization errors can be corrected to effectively dissolve visible bands while better preserving the true nature of an original video’s gradients and textures.

Another technical advantage of the disclosed techniques over the prior art is the disclosed techniques improve compression rates without compromising quality of viewing experience. Prior compression schemes dedicate significant bitrate to flat regions to prevent noticeable banding, or alternatively, resort to coarse smoothing making natural scenes appear artificial. The disclosed methods circumvent this problem by creating modified noise capable of actively concealing visible artifacts resulting from high compression. Such improvements allow encoders to operate at much lower bitrates and achieve substantial savings in network bandwidth that remain otherwise unattainable with earlier artifact concealment strategies.

Another technical advantage of the disclosed techniques over the prior art is the disclosed techniques integrate artifact concealment with natural film grain without sacrificing natural textures for less banding artifacts. By using natural film grain as a mechanism for concealment, a final video output stream will maintain a more organic, textured appearance compared to excessively artificial methods for debanding.

### A summary of the claims will be inserted here prior to filing

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to persons having ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for reducing visibility of banding artifacts, the method comprising:
receiving a video stream exhibiting a banding artifact at a portion of the video stream;
generating a filtered portion of the video stream from the portion of the video stream exhibiting the banding artifact;
generating, for at least one video frame of the video stream, an offset value based on a difference between the filtered portion of the video stream and the portion of the video stream;
generating modified noise for the at least one video frame based on the offset value; and
adding the modified noise to the video stream to generate an output video stream.

2. The computer-implemented method of claim 1, wherein filtering the portion of the video stream includes:
applying at least one of Gaussian filter, bandpass filter, or bilateral filter to the portion of the video stream.

3. The computer-implemented method of claim 1, wherein the modified noise comprises white Gaussian noise having a non-zero mean.

4. The computer-implemented method of claim 1, wherein the modified noise is selectively applied to a luma component and/or a chroma component of the video stream.

5. The computer-implemented method of claim 1, wherein an original source of the video stream includes natural film grain or noise at the portion of the original source, and the modified noise is added to a corresponding portion of the output video stream.

6. The computer-implemented method of claim 1, wherein filtering the portion of the video stream is performed at a two-dimensional portion of the at least one video frame of the video stream.

7. The computer-implemented method of claim 1, wherein filtering the portion of the video stream is performed across multiple video frames of the video stream.

8. The computer-implemented method of claim 1, wherein the modified noise is added to a series of frames of the output video stream.

9. The computer-implemented method of claim 1, further comprising, prior to generating the offset value, determining whether the at least one video frame includes a group of pixels exhibiting a threshold degree of banding.

10. The computer-implemented method of claim 9, wherein the offset value is generated when the group of pixels exhibits the threshold degree of banding, and the threshold degree of banding corresponds to a threshold difference between pixel luma values or pixel chroma values.

11. One or more non-transitory computer-readable media including instructions, executable by one or more processors, to cause the one or more processors to reduce visibility of banding artifacts, by performing the steps of:
receiving a video stream exhibiting a banding artifact at a portion of the video stream;
generating a filtered portion of the video stream from the portion of the video stream exhibiting the banding artifact;
generating, for at least one video frame of the video stream, an offset value based on a difference between the filtered portion of the video stream and the portion of the video stream;
generating modified noise for the at least one video frame based on the offset value; and
adding the modified noise to the video stream to generate an output video stream.

12. The one or more non-transitory computer-readable media of claim 11, wherein the steps further include, prior to generating the offset value, determining the banding artifact is present in chroma components or luma components for the video stream.

13. The one or more non-transitory computer-readable media of claim 11, wherein the steps further include, prior to generating the offset value, determining the banding artifact is present in a horizontal or vertical series of pixels.

14. The one or more non-transitory computer-readable media of claim 11, wherein the steps further include, prior to generating the offset value, determining the banding artifact is present in an area of pixels in the at least one video frame of the video stream.

15. The one or more non-transitory computer-readable media of claim 11, wherein the modified noise comprises white Gaussian noise having a non-zero mean.

16. The one or more non-transitory computer-readable media of claim 11, wherein the modified noise is selectively applied to a luma component and/or a chroma component of the video stream.

17. The one or more non-transitory computer-readable media of claim 11, wherein filtering the portion of the video stream is performed at a two-dimensional portion of the at least one video frame of the video stream.

18. The one or more non-transitory computer-readable media of claim 11, wherein filtering the portion of the video stream is performed across multiple video frames of the video stream.

19. The one or more non-transitory computer-readable media of claim 11, wherein the modified noise is added to a two-dimensional area of pixels for the output video stream.

20. A system, comprising:
one or more memories storing instructions; and
one or more processors coupled to the one or more memories that, when executing the instructions, reduce visibility of banding artifacts, perform the steps of:
receiving a video stream exhibiting a banding artifact at a portion of the video stream;
generating a filtered portion of the video stream from the portion of the video stream exhibiting the banding artifact;
generating, for at least one video frame of the video stream, an offset value based on a difference between the filtered portion of the video stream and the portion of the video stream;
generating modified noise for the at least one video frame based on the offset value; and
adding the modified noise to the video stream to generate an output video stream.
